(19) United States
(12) Patent Application Publication
(10) Pub. No.: US 2015/0371581 A1
(43) Pub. Date: Dec. 24, 2015

(54) VIDEO ANALYSIS DEVICE, DISPLAY DEVICE, MEASUREMENT METHOD FOR DISPLAY DEVICE, VIDEO CORRECTION METHOD FOR DISPLAY DEVICE

(71) Applicants: Satoru CHUMAN, (US); NEC DISPLAY SOLUTIONS, LTD., TOKYO (JP)

(72) Inventor: Satoru CHUMAN, Tokyo (JP)

(73) Assignees: Satoru CHUMAN; NEC Display Solutions, Ltd., Minato-ku, Tokyo (JP)

(21) Appl. No.: 14/766,634

(22) PCT Filed: Feb. 28, 2013
(86) PCT No.: PCT/JP2013/055575

§ 371 Date: Aug. 7, 2015

(51) Int. Cl. G09G 3/20

(52) U.S. Cl. CPC G09G 3/2003; G09G 2320/0626

(57) ABSTRACT

Provided are a frame unit having a substantially rectangular shape, wherein a rear side of the frame unit is detachable attached to an outer edge of a display device; light shielding plates arranged on an upper side and right and left sides of the frame unit; and a measurement unit provided at a front side of each light shielding plate, where the measurement unit measures a display state of the display device and outputs a measurement result to the display device.

### TECHNICAL FIELD

The present invention relates to a video analysis device, a display device, a measurement method for a display device, and a video correction method for a display device.

### BACKGROUND ART

When a video output from a display device is adjusted to obtain an appropriate display state, a menu utilized in the display device is activated and the menu displayed on the display screen is manually operated. For example, when such a menu is operated, it is possible to adjust the luminance and the display position of each video signal to be displayed on the display screen. In addition, the luminance or chromaticity of a display screen can be adjusted based on a measurement result received from a sensor that is built in an upper portion of the bezel of a liquid crystal display device or a measurement result received from an external sensor that is provided during the adjustment substantially at the center of the display screen. Such an external sensor may be fixed to an upper position of the display screen of the display device (see Patent Document 1).

### PRIOR ART DOCUMENT

### Patent Document

Patent Document 1: Japanese Unexamined Patent Application, First Publication No. 2003-294528.

### DISCLOSURE OF INVENTION

### Problem to be Solved by the Invention

In the adjustment of the display state of the display screen, when a menu screen is displayed on the display screen, it is displayed to overlap on a video corresponding to a video signal to be displayed, which degrades the information recognizability. Additionally, when a sensor provided at the bezel or an external sensor provided at the display screen is utilized, measurement is performed at a specific position on the display screen, and thus the entire screen cannot be measured. In order to the entire screen by utilizing an external sensor, it is necessary to repeat the measurements with the movement of the external sensors, it is not possible to measure the movement of the external sensor and then the relevant measurement, that is, the whole screen cannot be measured in one process.

In addition, when the display state is adjusted, if the display screen is affected by reflection or ambient light from the outside, it is difficult to obtain an appropriately adjusted display state.

Therefore, a problem to be solved is display state adjustment while the display screen is considerably affected by such a factor.

### Means for Solving the Problem

The present invention has a feature of having a frame unit having a substantially rectangular shape, wherein a rear side of the frame unit is detachable attached to an outer edge of a display device; light shielding plates arranged on an upper side and right and left sides of the frame unit; and a measurement unit provided at a front side of each light shielding plate, where the measurement unit measures a display state of the display device and outputs a measurement result to the display device.

The present invention also provides a display device, comprising:

an acquisition unit that acquires the measurement result from the video analysis device in accordance with a video analysis device as described above; and

a correction unit that corrects at least one of a luminance of the display screen, a color temperature of the display screen, and a position of a video signal displayed on the display screen, based on the acquired measurement result.

The present invention also provides a measurement method for a display device, the method comprising:

arranging light shielding plates on an upper side and right and left sides of a frame unit, which has a substantially rectangular shape, and detachable attaching a rear side of the frame unit to an outer edge of the display device; and

performing a measurement of a video displayed at the display device by utilizing a measurement unit provided at a front side of each light shielding plate.

The present invention also provides a video correction method for a display device, the method comprising:

detachable attaching a rear side of a frame unit to an outer edge of the display device, wherein light shielding plates are arranged on an upper side and right and left sides of the frame unit;

acquiring a measurement result for a measurement of a video displayed at the display device by utilizing a measurement unit provided at a front side of each light shielding plate; and

correcting at least one of a luminance of the display screen, a color temperature of the display screen, and a position of a video signal displayed on the display screen, based on the acquired measurement result.

### Effect of the Invention

The display state can be adjusted while the influence on the display screen is reduced.

### BRIEF DESCRIPTION OF THE DRAWINGS

FIG. 1 is a perspective view of a video analysis device 1 according to a first embodiment.

FIG. 2 is a schematic perspective view of a video analysis device 10 and a display device 20 according to a second embodiment.

FIG. 3 is a perspective view of a state where the video analysis device 10 is attached to the display device 20.

FIG. 4 is a schematic block diagram showing the configuration of the display device 20.

FIG. 5 is a flowchart utilized to explain the operation of the display device 20.

### MODE FOR CARRYING OUT THE INVENTION

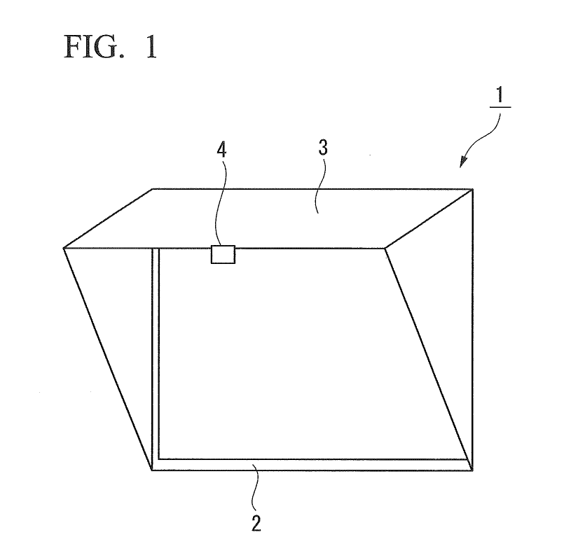

Below, embodiments of the present invention will be explained. FIG. 1 is a perspective view of a video analysis device according to a first embodiment.

The video analysis device 1 includes a frame unit 2, a light shielding plate 3, and a measurement unit 4. The frame unit 2 has a substantially rectangular shape and a rear side thereof can be detachably attached to the outer edge of a display device 20. The light shielding plate 3 is provided at the upper side and both (right and left) sides of the frame unit 2. The measurement unit 4 is provided at the front edge of the light shielding plate 3 so as to measure the display state of the display device and output measurement results to the display device. When a video displayed by the display device is analyzed by the video analysis device 1 and the analyzed result is output to the display device, it is possible to adjust the display state in the display device.

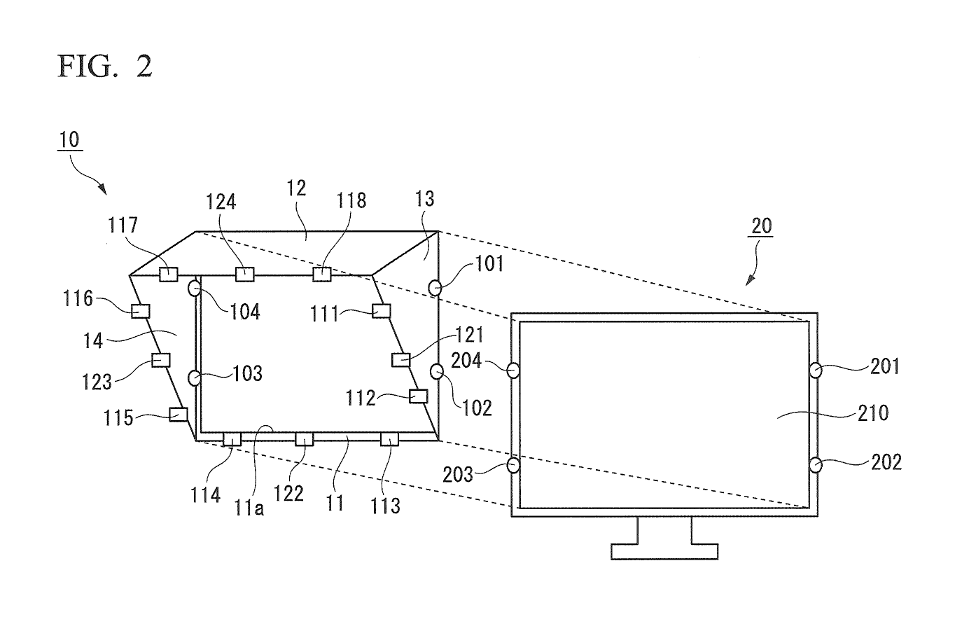

FIG. 2 is a schematic perspective view of a video analysis device 10 and a display device 20 according to a second embodiment. The video analysis device 10 can be detachably attached to the display device 20. FIG. 2 shows a state in which the video analysis device 10 is being detached from the display device 20.

The video analysis device 10 includes a frame unit 11, light shielding plates 12, 13, and 14, terminals 101, 102, 103, and 104, external sensors 111, 112, 113, 114, 115, 116, 117, and 118, and cameras 121, 122, 123, and 124.

The frame unit 11 has a substantially rectangular shape. The opening 11a of the frame unit 11 also has a substantially rectangular shape and substantially the same size as that of a display screen 210. Accordingly, when the frame unit is attached to the outer edge of the display device 20, the display screen 210 can be seen via the opening 11a. In addition, locking claws are provided at both ends of each of opposed longer sides of the frame unit 11. The rear side of the video analysis device 10 (i.e., the rear side of the frame unit 11) is attached to the display device 20 by engaging the locking claws with the outer edge of the display device 20. The video analysis device 10 can be detached from the display device 20 by disengaging the locking claws from the outer edge of the display device 20. The sizes of the frame unit 11 and the opening 11a can be appropriately changed according to the size of the display screen of the display device 20.

The light shielding plates 12, 13, and 14 are each provided on the front surface of the frame unit 11 (i.e., on a surface opposite to the surface which faces the display device 20). The light shielding plate 12 is attached to the upper side of the frame unit 11, and the light shielding plate 13 and 14 are attached respectively to the right and left sides of the frame unit 11. The right end of the light shielding plate 12 is joined to the upper end of the light shielding plate 13 and the left end of the light shielding plate 12 is joined to the upper end of the light shielding plate 14. These light shielding plates 12, 13, and 14 should be made of a material having a light shielding property, for example, a plastic resin, a metal plate, or the like, which has a light shielding property. The light shielding plates 13 and 14 each have a substantially triangular shape in which the distance from the frame unit 11 to the front edge gradually decreases from the upper side to the lower side of the triangle.

The terminals 101 and 102 are provided on the back surface of the right side of the frame unit 11, and the terminals 103 and 104 are provided on the back surface of the left side of the frame unit 11. On the right and left sides, the positions of the terminals 101, 102, 103, and 104 correspond to those of terminal 201, 202, 203, and 204 which are provided on the outer edge of the display device 20. When the video analysis device 10 is attached to the display device 20, the terminals 101, 102, 103, and 104 are respectively connected to the terminal 201, 202, 203, and 204. For example, the terminals 101 and 102 are arranged at points by which the left side of the frame unit 11 is divided into equal-length parts and the terminals 103 and 104 are arranged at points by which the left side of the frame unit 11 is divided into equal-length parts.

The external sensors 111, 112, 113, 114, 115, 116, 117, and 118 measure the luminance and the color temperature of the display screen. Here, each of the external sensors 111, 112, 113, 114, 115, 116, 117, and 118 may be a sensor having both functions of a luminance sensor and a color temperature sensor. In another example, some (for example, four) of the above external sensors may be luminance sensors and the remaining sensors may be color temperature sensors.

The external sensors 111 and 112 are provided in the vicinity of the front side (of the light shielding plate 13) which does not contact the frame unit 11 and the light shielding plate 12. The external sensors 111 and 112 are oriented so that they can measure the luminance and color temperature of the display screen. For example, the external sensors 111 and 112 are arranged at points by which the front side of the light shielding plate 13 is divided into equal-length parts.

The external sensors 113 and 114 are provided on the front surface of the lower side of the frame unit 11 and are oriented so that they can measure the luminance and color temperature of the display screen. For example, the external sensors 113 and 114 are arranged at points by which the lower side of the frame unit 11 is divided into equal-length parts.

The external sensors 115 and 116 are provided in the vicinity of the front side (of the light shielding plate 14) which does not contact the frame unit 11 and the light shielding plate 12. The external sensors 115 and 116 are oriented so that they can measure the luminance and color temperature of the display screen. For example, the external sensors 115 and 116 are arranged at points by which the front side of the light shielding plate 13 is divided into equal-length parts.

The external sensors 117 and 118 are provided in the vicinity of the front side (of the light shielding plate 12) which is opposed to the side that contacts the upper side of the frame unit 11. The external sensors 117 and 118 are oriented so that they can measure the luminance and color temperature of the display screen. For example, the external sensors 117 and 118 are arranged at points by which the front side of the light shielding plate 13 is divided into equal-length parts.

Since the external sensors 111, 112, 113, 114, 115, 116, 117, and 118 are provided at the light shielding plates 12, 13, and 14 and the lower side of the frame unit 11, measurement of the entire display screen of the display device 20 can be performed. For example, if the external sensor 111, 113, 115, and 117 are luminance sensors, the external sensor 111 measures the luminance of an upper right area of the display screen, the external sensor 113 measures the luminance of a lower right area of the display screen, the external sensor 115 measures the luminance of a lower left area of the display screen, and the external sensor 117 measures the luminance of an upper left area of the display screen.

In addition, if the external sensor 112, 114, 116, and 118 are chromaticity sensors, the external sensor 112 measures the chromaticity of an upper right area of the display screen, the external sensor 114 measures the chromaticity of a lower right area of the display screen, the external sensor 116 measures the chromaticity of a lower left area of the display screen, and the external sensor 118 measures the chromaticity of an upper left area of the display screen.

The cameras 121, 122, 123, and 124 are utilized to capture the size and position of a video signal displayed on the display screen of the display device 20.

The camera 121 is provided in the vicinity of the front side (of the light shielding plate 13) which does not contact the frame unit 11 and the light shielding plate 12. The camera 121 is oriented so that it can image the display screen. For example, the camera 121 is arranged in the vicinity of the center of the front side of the light shielding plate 13.

The camera 122 is provided on the front surface of the lower side of the frame unit 11 and is oriented so that it can image the display screen. For example, the camera 122 is arranged in the vicinity of the center of the lower side of the frame unit 11.

The camera 123 is provided in the vicinity of the front side (of the light shielding plate 14) which does not contact the frame unit 11 and the light shielding plate 12. The camera 123 is oriented so that it can image the display screen. For example, the camera 123 is arranged in the vicinity of the center of the front side of the light shielding plate 14.

The camera 124 is provided in the vicinity of the front side (of the light shielding plate 12) which is opposed to the side that contacts the upper side of the frame unit 11. The camera 124 is oriented so that it can image the display screen. For example, the camera 124 is arranged in the vicinity of the center of the front side of the light shielding plate 12.

Since the cameras 121, 122, 123, and 124 are provided at the light shielding plates 12, 13, and 14 and the lower side of the frame unit 11 respectively, imaging of the entire display screen of the display device 20 can be performed. For example, the camera 121 images, the camera 122 images an area in the vicinity of the upper side of the display screen, the camera 123 images an area in the vicinity of the right side of the display screen, the camera 124 images an area in the vicinity of the lower side of the display screen.

The display device 20 has the display screen 210 on which a video signal input from an external device is displayed. The display device 20 may be a liquid crystal display device. In the display device 20, the terminals 201, 202, 203, and 204 are provided on the outer edge of the display screen 210.

On the outer edge of the display screen 210, the terminals 201 and 202 are provided on the front surface of the right side. The positions of the terminals 201 and 202 respectively correspond to those of the terminals 101 and 102 so that the terminals 201 and 202 can be connected to the terminals 101 and 102 when the video analysis device 10 is attached to the display device 20.

Additionally, on the outer edge of the display screen 210, the terminals 203 and 204 are provided on the front surface of the left side. The positions of the terminals 203 and 204 respectively correspond to those of the terminals 103 and 104 so that the terminals 203 and 204 can be connected to the terminals 103 and 104 when the video analysis device 10 is attached to the display device 20.

Each of the terminals 201, 202, 203, and 204 may supply power, that is supplied from the display device 20, to one of the terminals 101, 102, 103, and 104 (of the video analysis device 10), to which the relevant terminal is connected. In addition, the terminals 201, 202, 203, and 204 may receive from the terminals 101, 102, 103, and 104 (of the video analysis device 10), to which the former terminals are respectively connected, relevant measurement results output from the external sensors 111, 112, 113, 114, 115, 116, 117, and 118 and the cameras 121, 122, 123, and 124 and supply the measurement results to the display device 20.

Here, power is supplied via any one of the terminals 201, 202, 203, and 204 supplies to the video analysis device 10 and, the result of the luminance measurement is supplied via any one of the remaining three terminals from the video analysis device 10 to the display device 20. Additionally, the result of the chromaticity measurement is supplied via any one of the remaining two terminals from the video analysis device 10 to the display device 20, and the result of the imaging which utilizes the camera 121, 122, 123, 124 is supplied via the remaining terminal from the video analysis device 10 to the display device 20.

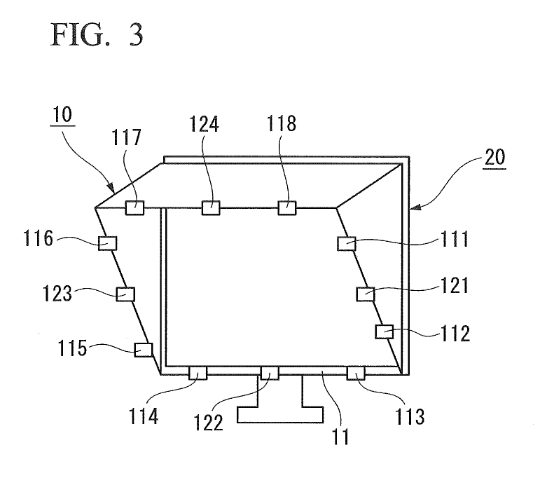

FIG. 3 is a perspective view of a state where the video analysis device 10 is attached to the display device 20. In the attachment, the rear side of the frame unit 11 in the video analysis device 10 faces the front side of the outer edge of the display device 20. In the state where the video analysis device 10 is attached to the display device 20, the external sensors 111, 112, 113, 114, 115, 116, 117, and 118 and the cameras 121, 122, 123, and 124 can perform the relevant measurements via the opening of the frame unit 11.

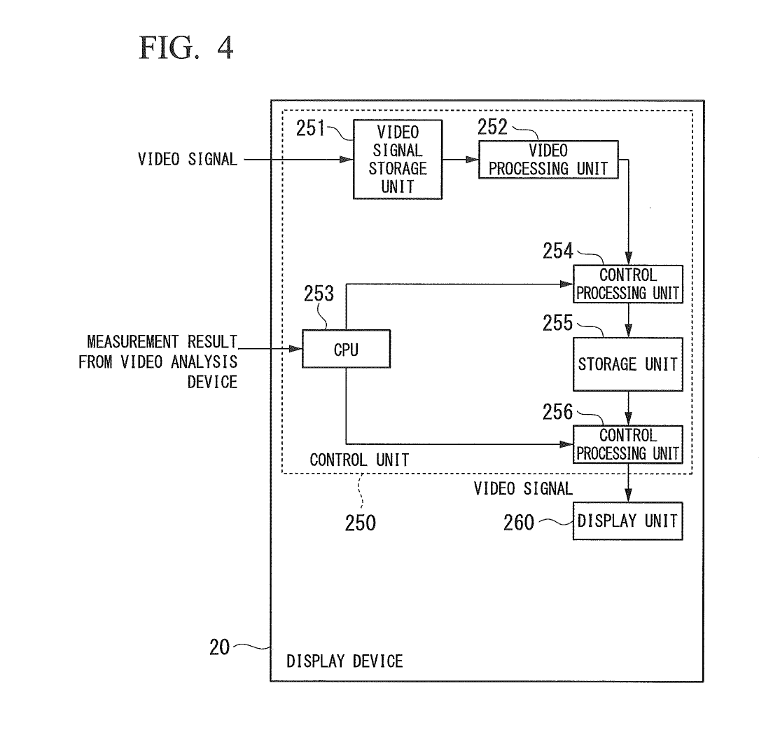

FIG. 4 is a schematic block diagram showing the configuration of the display device 20. The display device 20 has a control unit 250 and a display unit 260. The control unit 250 includes a video signal storage unit 251, a video processing unit 252, a CPU (central processing unit) 253, a control processing unit 254, a storage unit 255, and a control processing unit 256.

The video signal storage unit 251 temporarily stores a video signal supplied from an external video output device. The video processing unit 252 determines the resolution of the video signal which is temporarily stored in the video signal storage unit 251.

The CPU 253 controls the individual components (e.g., the control processing unit 254 and the control processing unit 256) in the control unit 250. The CPU 253 also supplies each measurement result, which is obtained from the video analysis device 10, to the control processing unit 254.

The control processing unit 254 corrects the video signal supplied by the video processing unit 252 based on a determination result for the resolution, which is supplied from the video processing unit 252, and measurement results obtained by the video analysis device 10, which is supplied from the CPU 253. The control processing unit 254 temporarily stores the corrected video signal in the storage unit 255. Here, based on the measurement results obtained by the video analysis device 10, the control processing unit 254 can correct at least one, or two or more of the luminance of the display screen, the color temperature of the display screen, and the position of the video signal displayed on the display screen.

The storage unit 255 temporarily stores the corrected video signal supplied from the control processing unit 254.

In response to an instruction from the CPU 253, the control processing unit 256 displays on the display unit 260, the video signal which is temporarily stored in the storage unit 255. The display unit 260 displays on its display screen, a video in accordance with a control signal supplied from the control processing unit 256.

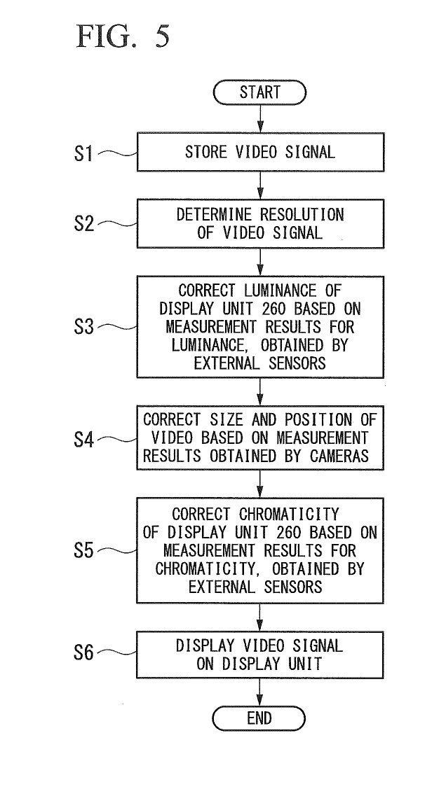

Below, the operations of the video analysis device 10 and the display device 20 which have the above-describe configurations will be explained. FIG. 5 is a flowchart utilized to explain the operation of the display device 20.

First, the video analysis device 10 is attached to the front side of the display device 20. According to this attachment of the video analysis device 10 to the display device 20, the display screen of the display device 20 is shielded from the external light by the light shielding plates 12, 13 and 14. The measurement utilizing the external sensors 111, 112, 113, 114, 115, 116, 117, and 118 and the imaging utilizing the cameras 121, 122, 123, and 124 can be performed while the influence by the external light is reduced. Moreover, the user can obtain an easily visible display screen. In addition, power is supplied to the video analysis device 10 from the display device 20.

The video signal storage unit 251 stores a video signal supplied from an external device (see step S1). The video processing unit 252 retrieves the video signal stored in the video signal storage unit 251 and determines the resolution thereof (see step S2). The CPU 253 acquires the measurement results and the imaging result, which are supplied from the video analysis device 10, and supplies the acquired information to the control processing unit 254.

The control processing unit 254 stores the video signal, which is output from the video processing unit 252, in the storage unit 255. Accordingly, the control processing unit 256 displays a corresponding video on the display unit 260. Here, for example, a test video utilized to correct the video signal is displayed.

The control processing unit 254 corrects the video signal by reflecting the measurement results from the video analysis device 10 (i.e., supplied via the CPU 253) onto the video signal (see step S3). More specifically, the control processing unit 254 corrects the luminance of the display unit 260 based on the measurement results for the luminance obtained by the external sensors 111, 113, 115, and 117.

For example, the brightness around the display device 20 is measured by utilizing the external sensors provided at the video analysis device 10. If the luminance of the display unit 260 in the display device 20 is higher in comparison with a peripheral brightness as the result of the above measurement, then the control processing unit 254 performs a luminance control to reduce the luminance of the display screen of the display unit 260. In contrast, if the luminance of the display unit 260 in the display device 20 is lower in comparison with the peripheral brightness as the result of the above measurement, then the control processing unit 254 performs a luminance control to increase the luminance of the display screen of the display unit 260.

The video processing unit 254, for example, stores a plurality of reference values associated with individual luminance values of the display screen. The video processing unit 254 computes an average of the measurement results from the external sensor 111, the external sensor 113, the external sensor 115, and the external sensor 117 and retrieves a reference value (among the above reference values) closest to the average. The video processing unit 254 adjusts the luminance of the display unit 260 so that the luminance of the display screen corresponds to the retrieved reference value.

In another example, the video processing unit 254, which stores a plurality of reference values associated with individual luminance values of the display screen, retrieves a reference value (among the above reference values) closest to the measurement result from the external sensor 111. The video processing unit 254 adjusts the luminance of the display unit 260 so that the luminance of the display screen corresponds to the retrieved reference value.

Similarly, the video processing unit 254 may measure (i) the luminance of a lower right area of the display screen based on the measurement result from the external sensor 113, (ii) the luminance of a lower left area of the display screen based on the measurement result from the external sensor 115, and (iii) the luminance of an upper left area of the display screen based on the measurement result from the external sensor 117.

Then the luminance on the display screen of the display unit 260, whose luminance has been adjusted, is again measured by using the external sensors of the video analysis device 10 and performs a comparison to determine whether or not the measured luminance corresponds to the peripheral brightness. If the luminance does not conform to the peripheral brightness, the process in step S3 is again executed. Before shifting to step S4, the process of step S3 may be repeated for a predetermined time (or a predetermined number of times) so that a luminance corresponding to the peripheral brightness can be obtained.

Next, based on the measurement results obtained from the cameras, the video processing unit 254 corrects the video size and the position of the video to be displayed on the display unit 260 (see step S4). For example, the control processing unit 254 obtains the measurement results, which are measured by the cameras 121, 122, 123, and 124 provided at the video analysis device 10, for the size and the position of the video signal displayed on the display unit 260. If the size and the position of the displayed video signal do not fit to the cabinet end (i.e., the outer edge of the display area of the display unit 260) of the display device 20, the video processing unit 254 controls the video signal so that the size and the position of the displayed video signal do not fit to the cabinet end of the display device 20.

For example, the video processing unit 254 determines whether or not the display size and the display position of the image according to the video signal fit to the cabinet end, based on (i) the imaging result of an area in the vicinity of the left side of the display screen, which is obtained by the camera 121, (ii) the imaging result of an area in the vicinity of the upper side of the display screen, which is obtained by the camera 122, (iii) the imaging result of an area in the vicinity of the right side of the display screen, which is obtained by the camera 123, and (iv) the imaging result of an area in the vicinity of the lower side of the display screen, which is obtained by the camera 124. In order that the display size and the display position of the image fit to the cabinet end, the video processing unit 254 performs enlargement or reduction of the display size or a change of the display position in the vertical and horizontal directions.

The control processing unit 254 determines whether or not the size and the position of the video signal after the above adjustment fit to the cabinet end. If they do not fit to the cabinet end, the process of step S4 is repeated so that the size and the position of the relevant screen fit to the cabinet end.

Next, the control processing unit 254 corrects the chromaticity of the display unit 260 based on the measurement results for the chromaticity, which are obtained from the relevant external sensors (see step S5). For example, the control processing unit 254 displays a video signal by which the entire screen of the display unit 260 has a color of white (i.e., full white) and measures the color temperature by utilizing the external sensors provided at the video analysis device 10. The control processing unit 254 corrects the chromaticity of the video signal so that the measured color temperature coincides with a color temperature designated by the user in advance.

After the correction of the chromaticity, the control processing unit 254 measures the color temperature of the corrected video signal (full white) by utilizing the external sensors of the video analysis device 10 and determines again whether or not the result of the measurement coincides with the designated color temperature. If the compared color temperatures do not coincide with each other, then the process of step S5 may be repeated for a predetermined time (or a predetermined number of times) before shifting to step S6.

The video processing unit 254 may store a chromaticity designated by the user and correct the chromaticity so that the measurement results obtained from the external sensor 112, the external sensor 114, the external sensors 116, and the external sensor 118 each coincide with the stored chromaticity.

Here, the chromaticity of an upper right area of the display screen of the display unit 260 may be corrected based on the chromaticity measurement result of the upper right area of the display screen, obtained by the external sensors 112, and the chromaticity of a lower right area of the display screen of the display unit 260 may be corrected based on the chromaticity measurement result of the lower right area of the display screen, obtained by the external sensors 114.

Similarly, the chromaticity of a lower left area of the display screen of the display unit 260 may be corrected based on the chromaticity measurement result of the lower left area of the display screen, obtained by the external sensors 116, and the chromaticity of an upper left area of the display screen of the display unit 260 may be corrected based on the chromaticity measurement result of the upper left area of the display screen, obtained by the external sensors 118.

The control processing unit 254 temporarily stores the corrected video signal in the storage unit 255. When the video signal is stored in the storage unit 255, the control processing unit 256 retrieves the video signal and outputs the signal to the display unit 260 (see step S6).

According to the embodiment described above, the video analysis device 10 is attached to the outside of the display device 20 in a manner such that the video analysis device 10 surrounds the display unit 260 of the display device 20, and measurement of the displayed video is performed by utilizing a plurality of external sensors and cameras provided at the video analysis device 10. Therefore, external effects such as reflection or ambient light from the outside onto the display screen can be blocked. In addition, information for the entire screen can be acquired in one process by utilizing the individual sensors (that include the external sensors and the cameras) provided at the video analysis device 10 which surrounds the display screen, where the user's line of sight is not blocked. It is therefore possible to adjust the screen so that the video signal is appropriately displayed. Furthermore, since the video correction can be performed in real time while the video is displayed, the user's information recognizability is not degraded.

Additionally, in the embodiment described above, when the video analysis device 10 is attached to the display device 20, the individual terminals (201, 202, 203, and 204) provided in the video analysis device 10 respectively contact the terminals (101, 102, 103, and 104) of the display device 20 so as to communicate the measurement results and supply electric power between the video analysis device 10 and the display device 20. Therefore, it is not necessary to use cables or the like for the connection of the individual external sensors and cameras, which can eliminate the complexity related to the handling of the cable.

While embodiments of the present invention have been described with reference to the drawings, specific structures are not limited to the embodiments. Modifications in design can be made without departing from the scope of the present invention.

### INDUSTRIAL APPLICABILITY

The above-described video analysis device 10 or display device 20 can be utilized as an video analysis device or a display device for medical use, graphic design, or the like.

### REFERENCE SYMBOLS

1, 10 video analysis device
2, 11 frame unit
3, 12, 13, 14 light shielding plate
20 display device
101, 102, 103, 104, 201, 202, 203, 204 terminal
111, 112, 113, 114, 115, 116, 117, 118 external sensor
121, 122, 123, 124 camera
210 display screen
250 control unit
251 video signal storage unit
252 video processing unit
254, 256 video processing unit
253 CPU
255 storage unit
260 display unit

1. A video analysis device comprising:
a frame unit having a substantially rectangular shape, wherein a rear side of the frame unit is detachable attached to an outer edge of a display device;
light shielding plates arranged on an upper side and right and left sides of the frame unit; and
a measurement unit provided at a front side of each light shielding plate, where the measurement unit measures a display state of the display device and outputs a measurement result to the display device.

2. The video analysis device in accordance with claim 1, wherein:
the measurement unit outputs the measurement result via a connection terminal provided at the frame unit and a connection terminal that is provided at the display device and is connected to the terminal of the frame unit.

3. A display device, comprising:
an acquisition unit that acquires the measurement result from the video analysis device in accordance with claim 1; and
a correction unit that corrects at least one of a luminance of a display screen, a color temperature of the display screen, and a position of a video signal displayed on the display screen, based on the acquired measurement result.

4. The display device in accordance with claim 3, wherein:
when the luminance of the display screen is corrected, the correction unit corrects the luminance of the display screen based on a relationship between a brightness around the display device, which is obtained from the measurement result, and the luminance of the display screen.

5. The display device in accordance with claim 3, wherein:
when the color temperature of the display screen is corrected, the correction unit:
compares the measurement result, which indicates a color temperature measured when a predetermined color is displayed on the display screen, with a reference value for the color temperature; and
corrects the color temperature of the display screen according to a result of the comparison.

6. The display device in accordance with claim 3, wherein:
when the position of the video signal displayed on the display screen is corrected, the correction unit corrects the position based on the measurement result for a measurement of the position of the video signal displayed on the display screen, in a manner such that the position at which the video signal is displayed fit to an end of a display area of the display screen.

7. A measurement method for a display device, the method comprising:
arranging light shielding plates on an upper side and right and left sides of a frame unit, which has a substantially rectangular shape, and detachable attaching a rear side of the frame unit to an outer edge of the display device; and
performing a measurement of a video displayed at the display device by utilizing a measurement unit provided at a front side of each light shielding plate.

8. A video correction method for a display device, the method comprising:
detachable attaching a rear side of a frame unit to an outer edge of the display device, wherein light shielding plates are arranged on an upper side and right and left sides of the frame unit;
acquiring a measurement result for a measurement of a video displayed at the display device by utilizing a measurement unit provided at a front side of each light shielding plate; and
correcting at least one of a luminance of a display screen, a color temperature of the display screen, and a position of a video signal displayed on the display screen, based on the acquired measurement result.
